(19) United States
(12) Patent Application Publication
(10) Pub. No.: US 2005/0108178 A1
(43) Pub. Date: May 19, 2005

(54) Order risk determination

(76) Inventor: Richard York, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/716,067

(22) Filed: Nov. 17, 2003

(51) Int. Cl. H04L 9/00

(52) U.S. Cl. 705/75

(57) ABSTRACT

In one embodiment, the invention provides a method of determining a risk for fraud for an order, including: receiving an order from a customer; evaluating an order based upon indicators of possible high risk activities; if the order is not classified as a high risk order, then evaluating the order based upon indicators of possible medium risk activities; and if the order is not classified as a medium risk activity, then classifying the order as a low risk order.

### TECHNICAL FIELD

Embodiments of the invention relate generally to the fraud prevention methods. More particularly, embodiments of the invention provide an apparatus, system, and method for determining a risk of fraud for an order.

### BACKGROUND

An incoming order (e.g., an order for particular product or service) may be placed by a customer via an online shopping website or via a call-center. Currently, when an incoming order is made by a customer, the incoming order will be reviewed for potential fraud by having an analyst examine the dollar amount of the incoming order. As a result, this current method is unable to detect for fraudulent orders that may have lower dollar amounts. Thus, it would be desirable to improve the current methods for verifying an order for potential fraud before the order is accepted or rejected.

Therefore, current technologies are limited in their capabilities and suffer from at least the above constraints and deficiencies.

### SUMMARY OF EMBODIMENTS OF THE INVENTION

In one embodiment, the invention provides a method of determining a risk for fraud for an order, including: receiving an order from a customer; evaluating an order based upon indicators of possible high risk activities; if the order is not classified as a high risk order, then evaluating the order based upon indicators of possible medium risk activities; and if the order is not classified as a medium risk activity, then classifying the order as a low risk order.

In another embodiment of the invention, an apparatus for determining a risk for fraud for an order, includes: a server configured to permit an analyst to evaluate an order based upon indicators of possible high risk activities; wherein if the order is not classified as a high risk order, then the order is evaluated based upon indicators of possible medium risk activities; and wherein if the order is not classified as a medium risk activity, then the order is classified as a low risk order.

In another embodiment, the invention provides a method of dynamically adjusting indicators for detecting fraud based upon observed trends in fraud activities, including: analyzing observed trends in fraud activities; dynamically adjusting indicators of high risk related to fraud, based upon the observed trends; and dynamically adjusting indicators of medium risk related to fraud, based upon the observed trends.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (or apparatus), in accordance with an embodiment of the invention.

FIG. 2 is a flowchart of a method of determining a risk for fraud for an order, in accordance with an embodiment of the invention.

FIG. 3 is a flowchart of a method of determining a risk for fraud for an order, in accordance with an embodiment of the invention.

FIG. 4 is a flowchart of a method of dynamically adjusting indicators for detecting fraud based upon observed trends in fraud activities, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

Embodiments of the invention provide various advantages such as, for example, allowing the detection of fraudulent orders by providing particular checks on an incoming order to verify the incoming order for potential fraudulent activity. Another advantage provided by embodiments of the invention is, for example, allowing a fraudulent order to be detected where the fraudulent order had originated from a geographical area(s) that has not been previously reviewed for potential fraudulent activities. Another advantage provided by embodiments of the invention is, for example, allowing a fraudulent order to be detected even if the fraudulent order is for a lower dollar amount.

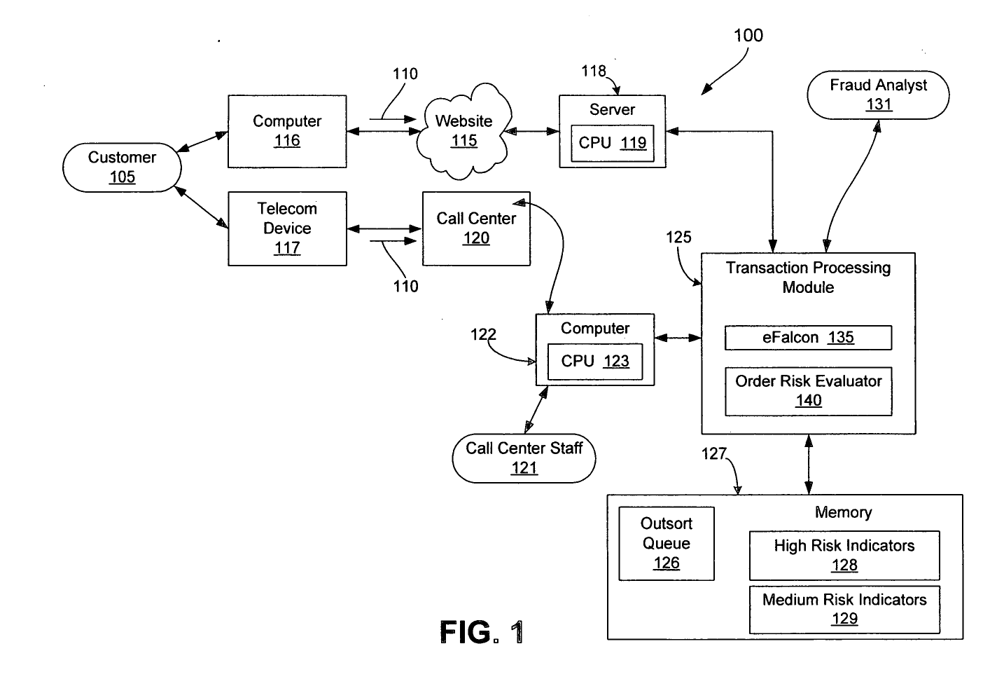

FIG. 1 is a block diagram of a system (or apparatus 100) in accordance with an embodiment of the invention. A customer 105 may send an order 110 via an online shopping website 115 or may send the order 110 by calling a call center 120. The order 110 may be, for example, an order for a particular product(s) and/or service(s).

Typically, to send an order 110 to the online shopping website 115, the customer 105 will use a computer 116 to access and place the order 110 on the website 115. Typically, to send an order 110 to the call center 120, the customer 105 will use a telecommunication (telecom) device 117 (e.g., telephone or cellular phone) to place the order 110 to the call center 120.

The online shopping website 115 may be, for example, an online shopping website provided by HEWLETT-PACKARD COMPANY at <www.HPShopping.com>), an internal company shopping website, or another online shopping website.

Typically, a server 118 (or other suitable computing device) is used to implement the website 115 and to receive and process the order 110 from the customer 105. The server 118 includes a processor 119 (e.g., a central processing unit) for executing various applications or programs that are accessible by the server 118. Similarly, the customer's computer 116 will also include a processor (not shown in FIG. 1) for executing various applications or programs in the computer 116. Various known components that are used in the server 118 and in the user's computer 116 are not shown in FIG. 1 for purposes of focusing on the functionalities of embodiments of the invention.

A call center staff 121 in the call center 120 typically has access to a computer 122 for processing an incoming order 110 that is received in the call center 120. Typically, each call center staff 121 will have access to a separate computer 122. The computer 122 includes a processor 123 (e.g., a central processing unit) for executing various applications or programs that are accessible by the computer 122.

In an embodiment of the invention, a transaction processing module 125 can determine if an order 110 is a high risk order (i.e., an order with a high risk related to fraudulent activity), a medium risk order (i.e., an order with a medium risk related to fraudulent activity), or a low risk order (i.e., an order with a low risk related to fraudulent activity). The transaction processing module 125 is typically implemented within the server 118. However, the transaction processing module 125 may alternatively be implemented in another computer (not shown in FIG. 1) that is accessible by the server 118 and by the call center staff computer 122.

Typically, an order 110 is first outsorted before the order 110 is determined as a high risk order, medium risk order, or low risk order. An order 110 is outsorted if the order 110 is selected among various incoming orders 110 and placed in a separate queue 126 for evaluation of the risk. An order 110 can be selected for outsort by use of any suitable methods, such as, for example, outsorting all incoming orders 110, outsorting randomly picked incoming orders 110, outsorting an incoming order 110 based upon one or more criteria that can be predefined by the user of the transaction processing module 125, and/or outsorting an incoming order 110 based upon other suitable methods. Typically, this outsort queue 126 is a memory area 126 that is in a memory 127. This memory 127 may be, for example, within the server 118, or within another computing device or memory storage device that can be accessed by the server 118 and call center staff computer 122. The method of evaluation of risk for an order is described below, in accordance with an embodiment of the invention.

In an embodiment, the transaction processing module may include an EFALCON module (or other suitable fraud analysis module) 135, and an order risk evaluator software 140. Therefore, the eFalcon module is just one example of the module 135. The server 118 and the call center staff computer 122 can access the transaction processing module 125. The server processor 119 and the call center staff computer processor 123 can each execute the fraud analysis module 135, order risk evaluator 140 and other software in the transaction processing module 125. The eFalcon module 135 is an e-commerce fraud detection product from FAIR, ISSAC AND COMPANY, San Rafael, Calif., and compares the transaction to general fraud patterns. The eFalcon module 135 can also compare the transaction to individual cardholder profiles to see where the transaction is consistent with the typical behavior of the individual. The eFalcon module 135 will provide a score that may be used as fraud probability information that can be used to decide if the transaction should be accepted or rejected. The order risk evaluator 140 can categorize an order 110 as a high risk order, medium risk order, or low risk order, based upon indicators 128 of high risk activities of fraud and indicators 129 of medium risk activities of fraud, as described below in additional details. The modules 135 and 140 may typically be implemented by use of software code.

In other embodiments, the order risk evaluator 140 may be implemented as new code within the eFalcon module 135 and executed by the eFalcon module 135 as a filter set to categorize an order as a high risk order, medium risk order, or low risk order. In other embodiments, the order risk evaluator 140 may be independent from the eFalcon module 135 and the eFalcon module 135 may be omitted from the transaction processing module 125. In other embodiments, the order risk evaluator 140 can be implemented as a web tool that can be accessed by use of a web interface. In other embodiments, the order risk evaluator 140 can be implemented to function with a database, such as a database available from ORACLE CORPORATION of Redwood Shores, Calif.

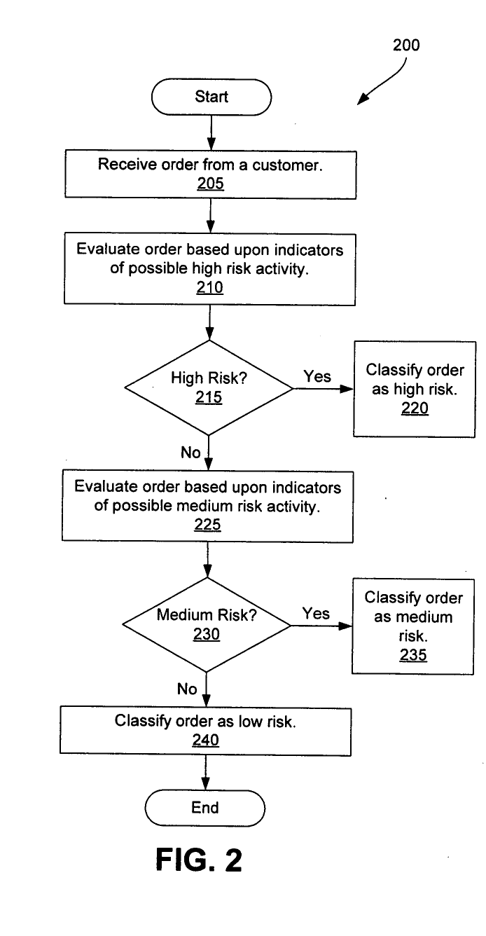

FIG. 2 is a flowchart of a method 200 of determining a risk for fraud for an incoming order 110, in accordance with an embodiment of the invention. An order 110 from a customer 105 is first received (205), by the website 115 or by the call center staff 121 in the call center 120. A customer 105 can order a product (e.g., a computer) or service by, for example, accessing the online shopping website 115 or by calling the call center 120, by use of the computer 116 or telecom device 117, respectively. The order 110 is then evaluated (210) based upon indicators 128 of possible high risk activity (i.e., “high risk indicators” or indicators of a high risk of fraudulent activity). The presence of any of these high risk indicators 128 will warrant a thorough investigation of the order by fraud analyst 131 (see FIG. 1) for potential fraud that may be related to the order 110, since the presence of any of these high risk indicators 128 provides a higher potential for financial loss for or charge-back to the vendor who will provide the product or service requested in the order 110. If a high risk indicator 128 is present, as noted in step (215), then the order 110 is classified (block 220) as a high risk activity (or high risk order), and an analyst 131 will perform further investigation of the order 110 and/or customer 105, as described below. When evaluating a high risk order, the analyst 131 will typically use more time and resource(s) to evaluate the possibility of fraud related to the order. For example, the analyst 131 may use more expensive and thorough online verification tools and devote more time investigating the order 110 and customer 105 for potential fraudulent activity relating to the order 110.

If, in step (215), none of the indicators 128 of possible high risk activity is present, then the order is evaluated (225) based upon indicators 129 of possible medium risk activity (i.e., “medium risk indicators” or indicators of a medium risk of fraudulent activity). The presence of any of these medium risk indicators 129 will warrant some investigation of the order 110 by an analyst 131 for potential fraud, since the presence of any of these indicators 129 provides some potential for financial loss for or charge-back to the vendor who will provide the product or service requested in the order 110. In an embodiment of the invention, the investigation by an analyst 131 for a medium risk order will typically not require as much time and/or resources as compared to the time and/or resources required for an investigation of a high risk order. If a medium risk indicator 129 is present, as noted in step (230), then the order 110 is classified (block 235) as a medium risk activity (or medium risk order), and the analyst 131 will perform some investigation of the order 110 and/or customer 105 for potential fraud relating to the order 110.

If, in step (230), none of the indicators 129 of possible medium risk activity is present, then the order 110 is classified (block 240) as a low risk activity (or low risk order). An order 110 that has been classified as a low risk order has a low potential for fraudulent activity. In an embodiment of the invention, a low risk order receives a lower priority as far as time and resources of the analyst 131. In one embodiment, a low risk order is approved for fulfillment if the analyst 131 is unable to evaluate the low risk order for fraud.

By classifying an order 110 as a high risk order, medium risk order, or low risk order, the time and resources of the analysts 131 may be significantly optimized. For example, more experienced analysts 131 can be assigned to the identified high risk orders and analysis of the high risk orders may increase in quality to prevent or reduce financial loss or charge-backs to the vendor. Other advantageous results may be achieved by being able to categorize an order 110 into a high risk, medium risk, or low risk category.

If an order 110 has been approved for fulfillment by an analyst 131, then the order 110 may typically flow through a suitable order fulfillment process. For example, if an analyst 131 evaluates a high risk order (or medium risk order) and determines that the order should be fulfilled since the investigation of the analyst 131 concluded a low fraud potential for the order 110, then the order 110 may typically flow through a suitable order fulfillment process. On the other hand, if the order 110 is rejected, then the order 110 may typically flow through a suitable fraud rejection process. For example, if an order 110 is rejected, then the customer 105 is sent an electronic mail (e-mail) message or phone call indicating that the order 110 was declined or cannot be fulfilled. The message or phone call may optionally indicate that the customer 105 is requested to seek another vendor for the requested product and/or service associated with the order. Other suitable order fulfillment processes or fraud rejection processes may be used in an embodiment of the invention.

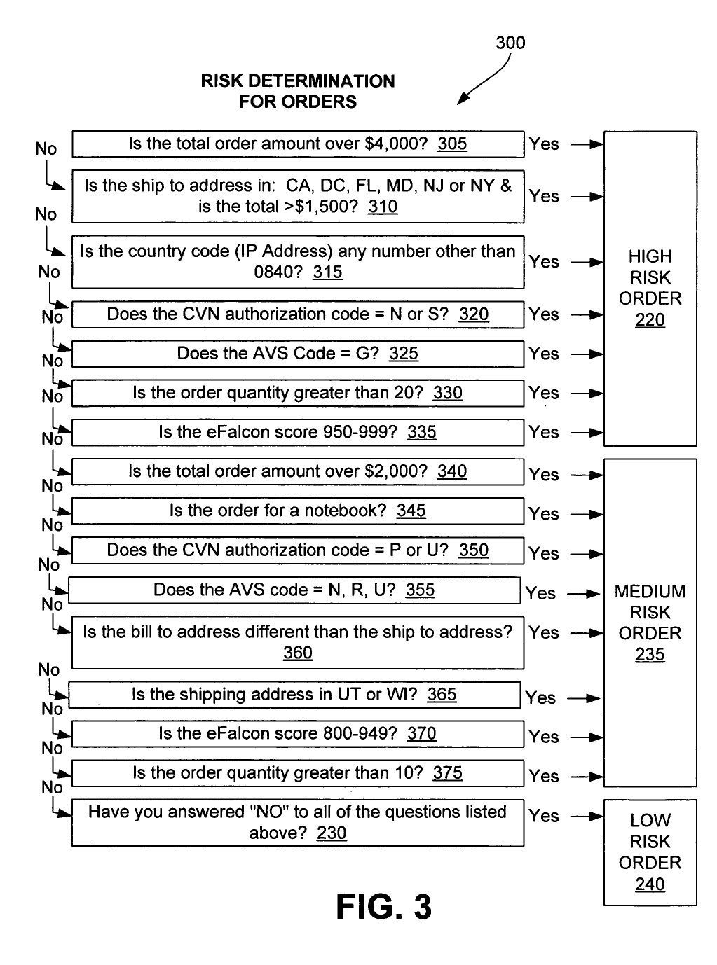

FIG. 3 is a flowchart of a method 300 of determining a risk for fraud for an order 110, in accordance with an embodiment of the invention. The method 300 illustrates particular factors or indicators that may be evaluated to determine if an order 110 is a high risk order, a medium risk order, or low risk order. The blocks 305 to 335 indicate various examples of high risk indicators 128, while the blocks 340 to 375 indicate various examples of medium risk indicators 129. The fraud analyst 131 (FIG. 1) will input various values or parameters, in response to various indicators that are asked and evaluated by the order risk evaluator 140 in blocks (305) to (375) and block (230) of the method 300.

It is noted that at least some of the blocks 305 to 335 may be omitted or modified so that the indicators 128 for determining a high risk order can be dynamically adjusted or modified based upon detected trends in fraudulent activity. It is also noted that the ordering of the blocks 305 to 335 may be varied and that the order shown in FIG. 3 is not to be construed to limit the scope of embodiment of the invention.

In block 305, a price amount of the order 110 is evaluated for a given high risk threshold amount, such as, for example, a high risk threshold amount of $4,000.00. It is noted that the high risk threshold amount may be set to other values. If the order 110 is over the high risk threshold amount, then the order 110 is classified (220) as a high risk order. An order 110 of a high dollar amount will be typically checked by an analyst 131 to minimize the potential financial loss for or charge back to the vendor.

If the order 110 is not over the high risk threshold amount, then the shipping address of the order 110 is checked in block 310. If the shipping address is to a designated high risk region, such as, for example, a particular state which has been historically designated as a shipping address for many fraudulent orders, then the order 110 is classified (220) as a high risk order. Particular states that have been historically designated as a shipping address for many fraudulent orders include, for example, California, District of Columbia, Florida, Maryland, New Jersey, and/or New York. These states indicate a high likelihood of being the shipping address for a fraudulent order. It is noted that the designated region(s) in block 310 may be changed, depending on the trends in fraudulent activities.

If the order 110 is not to be shipped to a designated region where a significant number of fraudulent orders are shipped, then the country code of the Internet-Protocol (IP) address of the customer 105 is checked in block 315, if the customer 105 placed the order 110 via the Internet or by use of other online commerce media. If the country code is any number other than 0840, then the country code will indicate that that the order 110 originated from an IP address that is outside the United States and the order 110 will be classified (220) as a high risk order.

If the order 110 originated from the United States (i.e., the country code is equal to 0840), then the card verification number (CVN) authorization code of the customer's credit card is checked in block 320. Most credit cards now include a 3 or 4 digit card verification number, which is not part of the regular credit card number. Telephone and Internet merchants can use these numbers to verify that the card is in fact in the customer's hand as the CVN numbers are not embedded in the magnetic stripe. If the CVN authorization code is equal to “N” (which means that there is no matched found for the CVN code) or if the CVN authorization code is equal to “S” (which means that a verification system being used by the analyst is unable to verify the CVN code), then the order 110 will be classified (220) as a high risk order.

If the CVN authorization code does not equal N or S, then the address verification code (AVS) is checked in block 325. The AVS code is a feature to verify the cardholder's address and zip code at the time of the transaction, to verify if the information that the cardholder has entered matches the information that is stored at the issuing bank. The AVS service is provided by, for example, VISA, MASTERCARD, and AMERICAN EXPRESS to verify the billing information provided by customers of the website. The AVS service matches the billing information provided by the customer with the billing information that is on file with the AVS service. This AVS file information is typically supplied by the sponsoring banks.

If the AVS code is equal to “G”, which means that the customer is using a foreign credit card, then the order 110 will be classified (220) as a high risk order.

If the AVS code does not equal G, then the quantity of the order 110 is checked in block 330. If the order 110 is greater than a high risk quantity threshold (e.g., 20 or some other pre-selected number), then the order 110 will be classified (220) as a high risk order.

If the order quantity is not over the high risk quantity threshold, then the eFalcon score is checked in block 335 by use of the eFalcon module 135. If the eFalcon score is within a particular range value (e.g., 950 to 999), then the order 110 will be classified (220) as a high risk order. It is noted that the importance or weight given to the eFalcon score in block 335 may be lessened due to the skewed score values that may result from the eFalcon algorithm. For example, a customer 105 who is ordering a product for the first time and who inadvertently types in a wrong address for his/her residence may receive an eFalcon score of over 900, even though there is less potential for fraud in this particular instance.

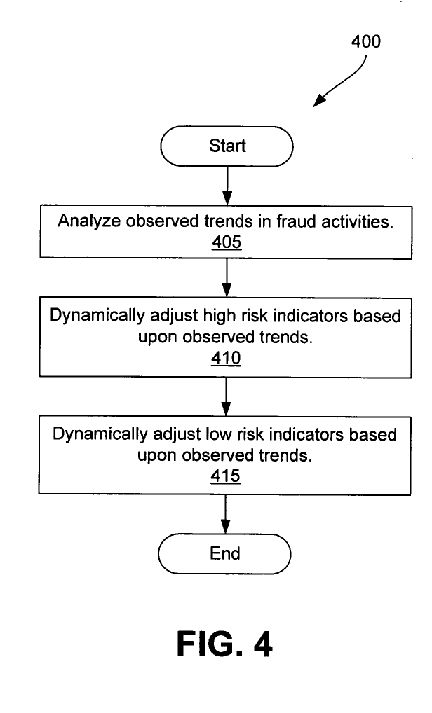

It is noted that at least some of the blocks 340 to 375 may be omitted or modified to other types of high risk indicators 128. As shown in FIG. 4 below, the indicators 128 may also be dynamically modified based on observed trends in fraud activities.

If the order 110 has not been classified as a high risk order, then a determination will be made if the order 110 is a medium risk order. It is noted that at least some of the blocks 340 to 375 may be omitted or modified so that the indicators 129 for determining a medium risk order can be dynamically adjusted or modified based upon detected trends in fraudulent activity. It is also noted that the ordering of the blocks 340 to 375 may be varied and that the order shown in FIG. 3 is not to be construed to limit the scope of embodiment of the invention. In block 305, an amount of the order 110 is evaluated for a given medium risk threshold amount, such as, for example $2,000.00. It is noted that the medium risk threshold amount may be set to other values. If the order 110 is over the medium risk threshold amount, then the order 110 is classified (220) as a medium risk order. As noted above, an analyst 131 will perform particular investigations of a medium risk order.

If the order 110 is not over the medium risk threshold amount, then a check is made if the order 110 is for a particular designated product (e.g., a notebook computer) in block 310. Notebook computers are often ordered in fraudulent transactions, since notebook computers are of high value and easily resold on Internet sites such as, for example, at the eBay website <www.ebay.com>. It is noted that the types of designated products may be changed, or other types of designated products may be added, or particular designated products may be eliminated, as products evolve due to advances in technology. For example, due to the increasing popularity of personal digital assistants to consumers, the personal digital assistant products may be added in the designated products category in block (345) in the method 300 of FIG. 3. If the order 110 is for a notebook computer (or other designated products), then the order 110 is classified (235) as a medium risk order.

If the order 110 is not for a notebook computer, then the card verification number (CVN) authorization code is checked in block 350. If the CVN authorization code is equal to “P” (which means that the CVN code could not be otherwise verified) or if the CVN authorization code is equal to “U” (which means that the CVN code is unavailable), then the order 110 will be classified (230) as a medium risk order.

If the CVN authorization code does not equal P or U, then the address verification code (AVS) is checked in block 355. If the AVS code is equal to “N” “R” or “U”, then the order 110 is classified (235) as a medium risk order. The code “N” means that there is no match found for the CVN code. The code R means that the system for checking the CVN code is down and that a retry has to be made to check the code. The code “U” means that the bank is not a participating bank.

If the AVS code does not equal N, R, or U, then a check is made if the billing address is different from the shipping address in block 360. If billing address is different from the shipping address, then the order 110 is classified (235) as a medium risk order.

If the billing address is not different from the shipping address, then a check is made if the shipping address is to a designated medium risk region (e.g., particular states) in block 365. In the example of FIG. 3, the particular states of designated medium risk regions include Utah and Wisconsin if the vendor has call centers in Utah or Wisconsin. The check performed in block 365 permits detection of a theft that is internally occurring within the vendor's organization (e.g., internal theft such as a call center staff shipping orders to an unauthorized destination such as a non-customer's address). If the shipping address is to a designated region (Utah or Wisconsin in the example of FIG. 3), then the order 110 is classified (235) as a medium risk order.

If the shipping address is not to a designated region, then the eFalcon score is checked in block 370. If the eFalcon score is within a particular range value (e.g., 800 to 949), then the order 110 will be classified (235) as a medium risk order. It is noted that the importance or weight given to the eFalcon score in block 370 may be lessened due to the skewed score values that may result from the eFalcon algorithm.

If the eFalcon score is not between a particular range of values, then the quantity of the order 110 is checked in block 375. If the order quantity is greater than a particular medium risk threshold amount (e.g., an amount of 10), then the order 110 will be classified (235) as a medium risk order.

If the order 110 is not above the particular medium risk threshold amount, and if none of the risk indicators are present (as noted in step 230), then the order 110 will be classified (240) as a low risk order, and the analyst 131 can analyze the low risk order as indicted above.

It is noted that at least some of the blocks 340 to 375 may be omitted or modified to other types of medium indicators 129. As shown in FIG. 4 below, the medium risk indicators 129 may also be dynamically modified based on observed trends in fraud activities.

FIG. 4 is a flowchart of an embodiment of a method 400 of dynamically adjusting indicators for detecting fraud based upon observed trends in fraud activities. The observed trends in fraud activities may be analyzed by a vendor or an analyst 131 working for the vendor. For example, if there has been an observed increase in fraudulent orders that are shipped to Arizona, then the check in block 310 (FIG. 3) will be dynamically adjusted (410) so that the state of Arizona is included among shipping addressed that are checked to determine if an order 110 is a high risk order. Other observed trends may be used to dynamically adjust or change (410) the high risk indicators 128 (e.g., add, remove, or modify a high risk indicator 128 for determining a high risk order).

The observed trends may also be analyzed to dynamically adjust (415) the medium risk indicators 129. For example, if it has been observed that there is an increasing number of fraudulent orders for digital cameras, then the check in block 345 may be modified to include checking if the order 110 is for a digital camera to determine if the order 110 is a medium risk order. Other observed trends may be used to dynamically adjust or change (415) the medium risk indicators 129 (e.g., add, remove, or modify a medium risk indicator 129 for determining a medium risk order).

The system of certain embodiments of the invention can be implemented in hardware, software, or a combination thereof. In at least one embodiment, the system is implemented in software or firmware that is stored in a memory and that is executed by a suitable instruction execution system. If implemented in hardware, as in an alternative embodiment, the system can be implemented with any suitable technology as known to those skilled in the art.

The various engines or modules or software discussed herein may also be, for example, computer software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of determining a risk for fraud for an order, the method comprising:
receiving an order from a customer;
evaluating an order based upon indicators of possible high risk activities;
if the order is not classified as a high risk order, then evaluating the order based upon indicators of possible medium risk activities; and
if the order is not a medium risk activity, then classifying the order as a low risk order.

2. The method of claim 1, wherein a high risk order is evaluated with more time than a medium risk order.

3. The method of claim 1, wherein a high risk order is evaluated with more resources than a medium risk order.

4. The method of claim 1, wherein a low risk order is evaluated with less resource than a high risk order and medium risk order.

5. The method of claim 1, wherein a low risk order is evaluated with less time than a high risk order and medium risk order.

6. The method of claim 1, wherein an indicator of possible high risk activities include at least one of:
an order amount over a high risk amount threshold;
a shipping address for the order to a particular high risk region;
a non-domestic Internet Protocol address of the customer;
a card verification number authorization code having a value from a first group of code values;
an address verification code indicating a foreign credit card by the customer; and
an order quantity over a high risk quantity threshold.

7. The method of claim 1, wherein an indicator of possible high risk activities further includes:
an eFalcon score within a first range of values.

8. The method of claim 1, wherein an indicator of possible medium risk activities include at least one of:
an order amount over a medium risk amount threshold;
an order for a particular designated product;
a card verification number authorization code having a value from a second group of code values;
an address verification code indicating a particular value from a group of CVN code values;
a billing address differing from a shipping address;
a shipping address to a medium risk region; and
an order quantity over a medium risk quantity threshold.

9. The method of claim 1, wherein an indicator of possible medium risk activities further includes:
an eFalcon score within a second range of values.

10. The method of claim 1, wherein the order is received in a website.

11. The method of claim 1, wherein the order is received in a call center.

12. The method of claim 1, wherein the order is an order for a product.

13. The method of claim 1, wherein the order is an order for a service.

14. An apparatus of determining a risk for fraud for an order, the method comprising:
means for receiving an order from a customer;
means for evaluating an order based upon indicators of possible high risk activities, wherein if the order is not classified as a high risk order, then evaluating the order based upon indicators of possible medium risk activities; and wherein if the order is not a medium risk activity, then classifying the order as a low risk order.

15. An article of manufacture, comprising:
a machine-readable medium having stored thereon instructions to:
receive an order from a customer;
evaluate an order based upon indicators of possible high risk activities, wherein if the order is not classified as a high risk order, then evaluate the order based upon indicators of possible medium risk activities; and wherein if the order is not a medium risk activity, then classify the order as a low risk order.

16. A method of dynamically adjusting indicators for detecting fraud based upon observed trends in fraud activities, the method comprising:
analyzing observed trends in fraud activities;
dynamically adjusting indicators of high risk related to fraud, based upon the observed trends; and
dynamically adjusting indicators of medium risk related to fraud, based upon the observed trends.

17. The method of claim 16, wherein an indicator of high risk related to fraud include at least one of:
an order amount over a high risk amount threshold;
a shipping address for the order to a particular high risk region;
a non-domestic Internet Protocol address of the customer;
a card verification number authorization code having a value from a first group of code values;
an address verification code indicating a foreign credit card by the customer; and
an order quantity over a high risk quantity threshold.

18. The method of claim 16, wherein an indicator of high risk related to fraud further includes:
an eFalcon score within a first range of values.

19. The method of claim 16, wherein an indicator of medium risk related to fraud include at least one of:
an order amount over a medium risk amount threshold;
an order for a particular designated product;
a card verification number authorization code having a value from a second group of code values;
an address verification code indicating a particular value from a group of CVN code values;
a billing address differing from a shipping address;
a shipping address to a medium risk region; and
an order quantity over a medium risk quantity threshold.

20. The method of claim 16, wherein an indicator of medium risk related to fraud further includes:
an eFalcon score within a second range of values.

21. An apparatus for determining a risk for fraud for an order, the apparatus comprising:
a server configured to permit an analyst to evaluate an order based upon indicators of possible high risk activities;
wherein if the order is not classified as a high risk order, then the order is evaluated based upon indicators of possible medium risk activities; and
wherein if the order is not classified as a medium risk activity, then the order is classified as a low risk order.

22. The apparatus of claim 21, wherein a high risk order is evaluated with more time than a medium risk order.

23. The apparatus of claim 21, wherein a high risk order is evaluated with more resources than a medium risk order.

24. The apparatus of claim 21, wherein a low risk order is evaluated with less resource than a high risk order and medium risk order.

25. The apparatus of claim 21, wherein a low risk order is evaluated with less time than a high risk order and medium risk order.

26. The apparatus of claim 21, wherein an indicator of possible high risk activities include at least one of:
an order amount over a high risk amount threshold;
a shipping address for the order to a particular high risk region;
a non-domestic Internet Protocol address of the customer;
a card verification number authorization code having a value from a first group of code values;
an address verification code indicating a foreign credit card by the customer; and
an order quantity over a high risk quantity threshold.

27. The apparatus of claim 21, wherein an indicator of possible high risk activities further includes:
an eFalcon score within a first range of values.

28. The apparatus of claim 21, wherein an indicator of possible medium risk activities include at least one of:
an order amount over a medium risk amount threshold;
an order for a particular designated product;
a card verification number authorization code having a value from a second group of code values;
an address verification code indicating a particular value from a group of CVN code values;
a billing address differing from a shipping address;
a shipping address to a medium risk region; and
an order quantity over a medium risk quantity threshold.

29. The apparatus of claim 21, wherein an indicator of possible medium risk activities further includes:
an eFalcon score within a second range of values.

30. The apparatus of claim 21, wherein the order is received in a website.

31. The apparatus of claim 21, wherein the order is received in a call center.

32. The apparatus of claim 21, wherein the order is an order for a product.

33. The apparatus of claim 21, wherein the order is an order for a service.
